(19) United States
(12) Patent Application Publication
(10) Pub. No.: US 2017/0144024 A1
(43) Pub. Date: May 25, 2017

(54) ATHLETICS COACHING SYSTEM AND METHOD OF USE

(71) Applicant: VB Instruction, LLC, Grand Rapids, MI (US)

(72) Inventors: Amber Lynn Warners, Grand Rapids, MI (US); Stephen Moser, Grand Rapids, MI (US)

(21) Appl. No.: 14/952,306

(22) Filed: Nov. 25, 2015

(51) Int. Cl. A63B 24/00; H04L 29/06; G06T 7/20; H04R 3/00; H04N 5/77; H04N 7/18; A63B 69/00; H04W 84/18

(52) U.S. Cl. CPC A63B 24/0062; A63B 69/00; H04L 65/40; H04W 84/18; H04R 3/005; H04N 5/772; H04N 7/183; G06T 7/20; A63B 2208/0204; H04R 2420/01; G06T 2207/30221

(57) ABSTRACT

A system and method for an athletics training and communication is provided. The method includes: providing a wireless communications device configured to receive sounds made by a player wearing the device during an athletic event; wirelessly transmitting the sounds made by the player to a media player; recording the sounds made by the player using the media player; video recording the athletic event; transmitting the recorded video to the media player; synchronously playing on the media player the recorded sounds and video of the athletic event; and reviewing and analyzing the sounds and the video together to evaluate the player's performance during the athletic event.

### BACKGROUND OF THE INVENTION

The present invention relates to a system and method for athletic training and communication, and more specifically to a system and method for reviewing and analyzing a team or teammate's performance during an athletic event.

### SUMMARY OF THE INVENTION

The present invention provides a method for athletic training including: (a) providing a wireless communications device configured to receive sounds made by a player wearing the device during an athletic event; (b) wirelessly transmitting the sounds made by the player to a media player; (c) recording the sounds made by the player using the media player; (d) video recording the athletic event; (e) transmitting the recorded video to the media player; (f) synchronously playing on the media player the recorded sounds and video of the athletic event; and (g) reviewing and analyzing the sounds and the video together to evaluate the player's performance during the athletic event.

In one embodiment, the method includes selectively choosing one or more of the communication devices for transmitting and recording the sounds made by one or more respective players during the same athletic event or during one of a series of athletic events.

In another embodiment, the method includes providing, to the coach, a wireless communication device configured to transmit audible instructions made by the coach. The method also includes providing an ear piece worn by the player; and transmitting, in real-time, the audible instructions made by the coach to the ear piece worn by the player, such that communication between the player and the instructor is two-way wireless communication. The transmission of such signals from the coach may be done at the same time as sounds made by one or more players are being recorded.

In yet another embodiment, an athletics training and communication system for use by a coach and members of an athletic team is provided. The training system includes a first wireless communication device configured to transmit sounds made by a first player during an athletic event or practice. The training system also includes a media player configured to receive and record the transmitted sounds made by the first player and a video camera for recording the athletic event or practice, the video camera configured to transmit the video stream to the media player. Further, the media player may synchronously play the sounds made by the first player and the video such that the first player's performance during the athletic event or practice can be reviewed and analyzed by contemporaneously watching the first player in the video and listening to the sounds made by the first player.

The training system may include a plurality of players' microphones, a coach's microphone, and a plurality of ear pieces for the players and/or coach. The training system may include a mixer and a user input for selectively controlling which of the plurality of microphones is transmitting. Further, the mixer and user input are configured to selectively control which of the ear pieces worn by the respective players is receiving the audible instructions, and to selectively control which of the sounds made by the players and the audible instructions made by the coach are played on the media player, such that the player(s)' performance during the athletic event or practice can be reviewed and analyzed.

### BRIEF DESCRIPTION OF THE DRAWINGS

FIG. 1 is a schematic representation of an athletics training and communication system according to an embodiment of the invention;

FIG. 2 is an exemplary view of an athlete wearing a wireless communication device and ear piece of the athletics training and communication system;

FIG. 3 is a flow chart for a method of athletics training according to an embodiment of the invention; and

FIG. 4 is a flow chart for a method of athletics training according to another embodiment of the invention.

### DETAILED DESCRIPTION OF THE CURRENT EMBODIMENT

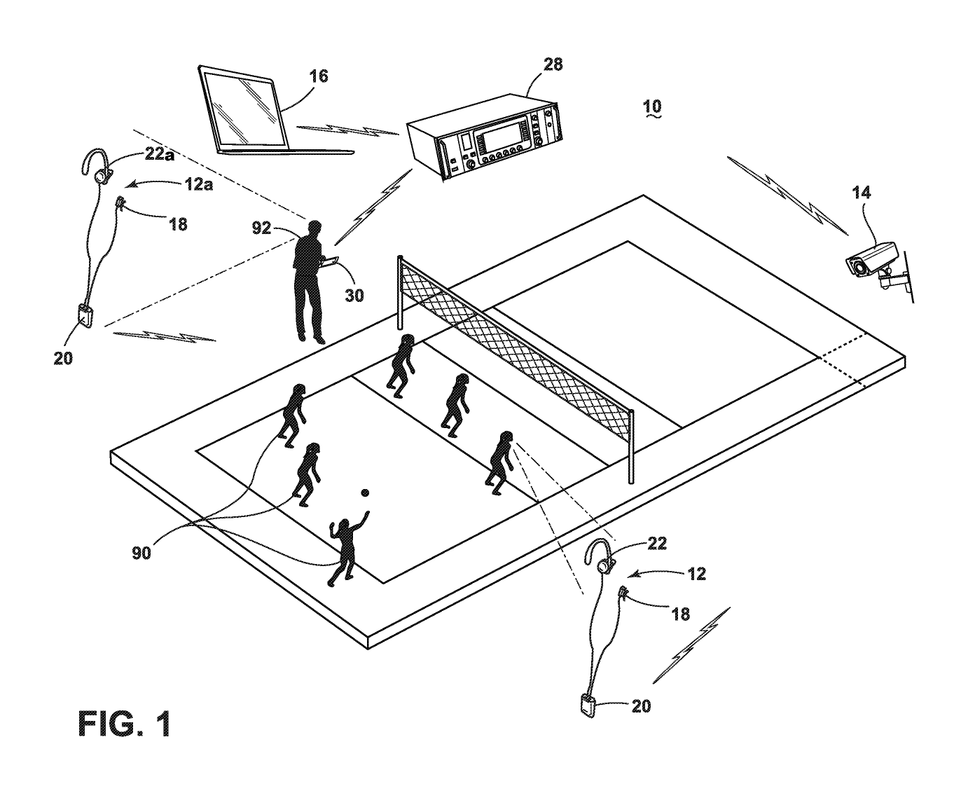

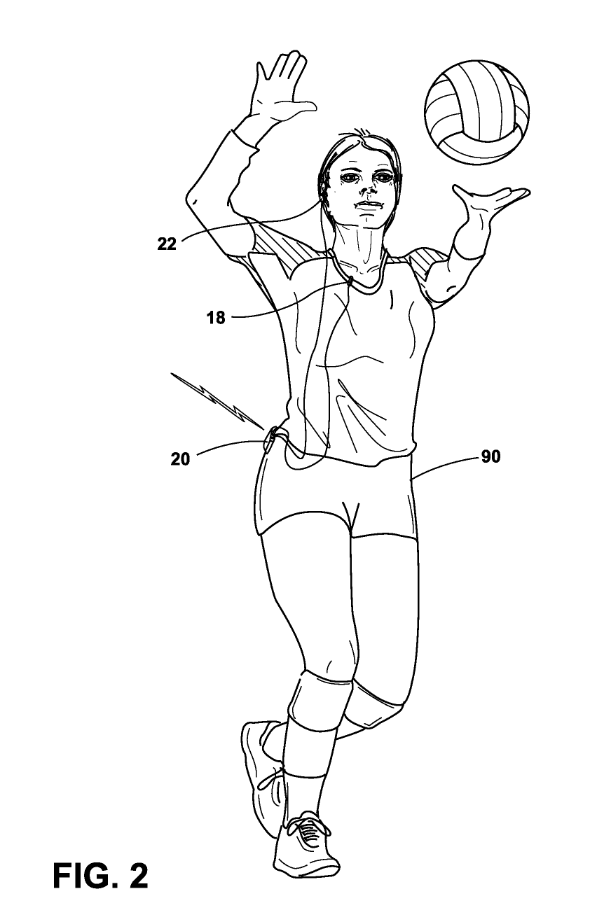

Referring to FIGS. 1-2, an athletics training and communication system 10 is shown in accordance with an embodiment of the present invention. In particular, the athletics training and communication system is for use by a coach and members of an athletic team, as well as by an individual athlete. Exemplary sports teams include, but are not limited to, volleyball, soccer, hockey, football, baseball, basketball, and tennis.

Athletics Training and Communication System

The training system 10 includes one or more wireless communication devices 12, a video camera 14, and a media player 16. The wireless communication devices 12 are in wireless communication with at least the media player 16 and include a microphone 18, such as a lavalier, and a transmitter 20. The microphone 18 is configured to receive sounds made by an associated player 90 during an athletic event or practice, and the transmitter 20 is configured to receive and transmit the sounds from the microphone 18. In addition, a communication device 12a may be provided to a coach 92 for transmitting audible instructions made by the coach 92. The microphone 18 and transmitter 20 may be integrated into a single unit, or may be separate components, and may include a clip or other attachment means for mounting the microphone 18 and transmitter 20 to the player's and coach's clothing or body.

Optionally, the communication device 12 may include an ear piece 22. The ear piece 22 is in wireless communication with the coach's communication device 12a and may receive and play the audible instructions made by the coach 92. It is understood that the ear piece 22 may be included in a helmet, goggles, hat, headband, or any other type of headgear known in the art. Further, the coach may also be provided with an ear piece 22a, configured to receive and play the sounds made by the players 90. Together, the communication devices 12 and 12a and the ear pieces 22 provide real-time, two-way oral communication between the players 90 and the coach 92.

The training system 10 includes a digital mixer 28 and a user interface 30. The digital mixer 28 is in communication with both the media player 16 and the communication devices 12, 12a and controls which of the communication devices 12, 12a is transmitting and/or being recorded by the media player 16. Further, the digital mixer 28 may also be in communication with the ear pieces 22, and may control which of the ear pieces 22 worn by the player 90 is receiving the audible instructions made by the coach 92. The user interface 30 allows a user, likely the coach 92 or an assistant, to selectively transmit the sounds made by one or more of the players 90 and/or the audible instructions made by the coach 92 to an individual player or group of team members. Similarly, the user interface 30 also allows a user to selectively control which ear pieces 22 are receiving the sounds and/or audible instructions. The user interface 30 may be in the form of an electronic device which allows a user to control the digital mixer 28.

The video camera 14 is configured to record the athletic event or practice and transmit the video stream to the media player 16. Alternatively, the video camera 14 may transmit (but not record) the video stream and the media player 16 may record the video stream. The video camera 14 may be oriented to record the entire playing field or court, a particular position on the field or court, a particular team member, or any other user-selected location. Further, multiple cameras may be utilized.

The media player 16 is configured to receive and record the transmitted sounds made by one or more of the players 90, the audible instructions made by the coach 92, and the video stream of the athletic event or practice. The media player 16 may be any suitable electronic device capable of playing both audio and video feeds. For example, the media player 16 may be a computer, smart television, or other suitable computing device.

The media player 16 can synchronously play the sounds made by the player(s) 90, the audible instructions made by the coach 92, and the recorded video stream such that the team's performance can be reviewed an analyzed by watching the video while contemporaneously listening to the sounds made by player(s) 90 and coach 92. Further, the user interface 30 enables the user to select which verbal communication can be listened to during playback. For example, to review a first player's performance, the user may select, with the user interface 30, to listen to the first player's sounds made during play while simultaneously watching that player's actions on the video. This allows the coach 92 and/or player to listen to the sounds the player is making while watching their performance.

Various aspects of a player's performance can be reviewed and analyzed by utilizing the training system 10. Exemplary performance aspects that can be reviewed and analyzed include the presence or absence of meaningful communication, negative and/or positive self-talk, and the player's skill at comprehending game strategies and tactics. Analyzing what type of communication is being spoken on the court or playing field, and whether the player is talking too much or too little, can be beneficial to a team or coach. Further, it can be determined if a player is speaking meaningful words that enhance or detract from the performance of the team.

In the case of two-way communication between one or more of the players 90 and the coach 92, the training system 10 enable immediate feedback, as well as private conversation. The coach 92 and player 90 can communicate and give instant feedback on decisions and performance during play. Further, the coach 92 can relay strategies or make observations to a player 90 without the opponent knowing what is being communicated.

Method of Athletics Training

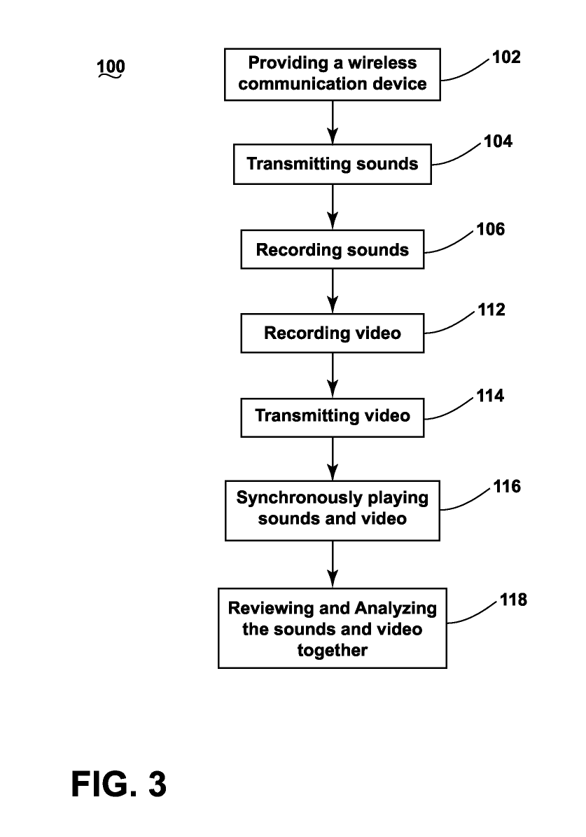

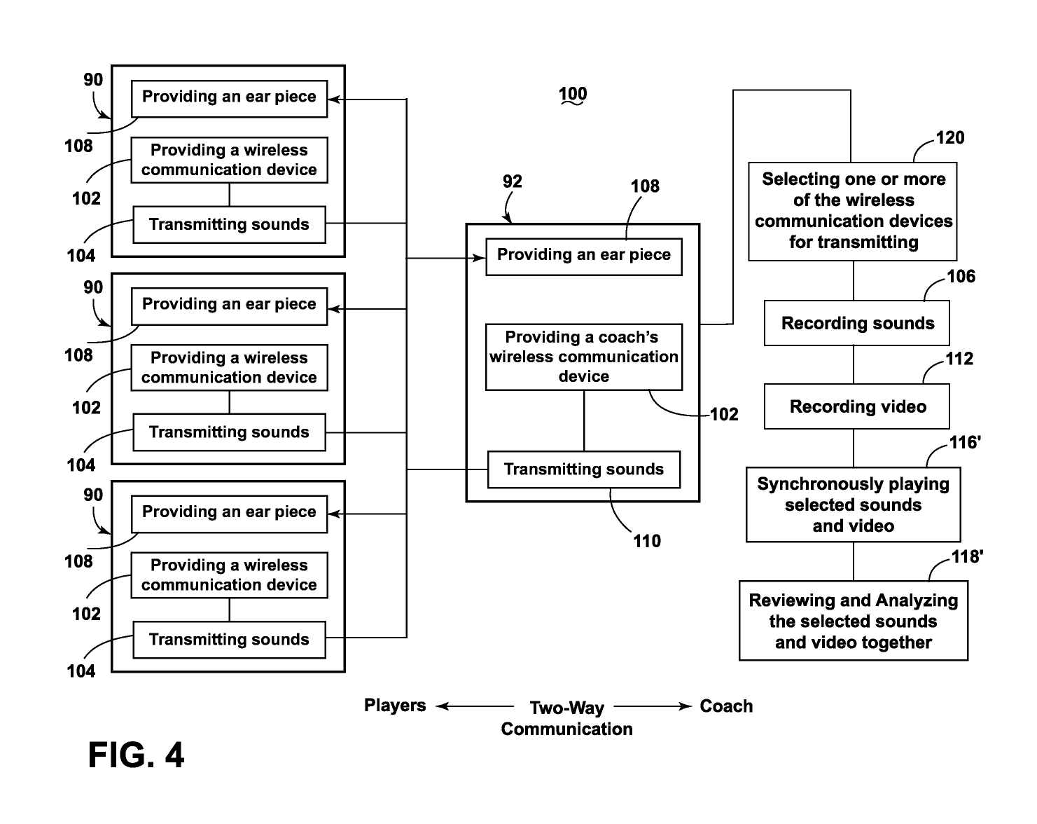

The above training system is presented in greater detail in connection with the flow chart of FIGS. 3-4. In particular, the flow chart of FIG. 3 includes a method 100 of athletics training. The method 100 including: (a) providing a wireless communications device configured to receive sounds made by a player wearing the device during an athletic event; (b) wirelessly transmitting the sounds made by the player to a media player; (c) recording the sounds made by the player using the media player; (d) video recording the athletic event; (e) transmitting the recorded video to the media player; (f) synchronously playing on the media player the recorded sounds and video of the athletic event; and (g) reviewing and analyzing the sounds and the video together to evaluate the player's performance during the athletic event.

The step of providing a wireless communications 12 device configured to receive sounds made by a player 90 wearing the device 12 during an athletic event is depicted by reference numeral 102 in FIG. 3. As described above, the communication device 12 may include the microphone 18, transmitter 20, and an optional an ear piece 22. Optionally, step 102 may include providing a plurality of communication devices 12 to a plurality of players 90. Further optionally, a coach's communication device 12a may be provided to the coach 92.

Wirelessly transmitting the sounds made by the player 90 to the media player 16 is depicted as step 104, and recording the sounds with the media player 16 is depicted as step 106. If a plurality of communication devices 12 are used by a number of players 90, steps 104 and 106 include transmitting and recording the sounds made by the plurality of players 90.

Optional steps are depicted as steps 108 and 110 in FIG. 4. These steps optionally provide an ear piece 22 to be worn by the player 90, and transmitting, in real-time, audible instructions made by the coach 92 to the ear piece 22 worn by the player 90. The coach 92 may also be provided with an ear piece 22. In this manner, communication between the player 90 and the coach 92 is considered real-time, two-way wireless communication.

Video recording the athletic event is depicted as step 112, and transmitting the recorded video to the media player is depicted as step 114. Step 112 generally includes orienting the video camera 14 to record the entire playing field or court, a particular position on the field or court, a particular player, or any other user-selected location. Further, multiple cameras may be utilized. Alternatively, the video camera 14 may transmit the video stream, and the media player 16 may record the video stream.

Synchronously playing on the media player the recorded sounds and video of the athletic event is depicted as step 116. This step may also include playing the audible instructions made by the coach 92 in the instance where the coach 92 is provided a coach's communication device 12a also.

Reviewing and analyzing the sounds and the video together to evaluate the player's performance during the athletic event is depicted as step 118. This step generally includes reviewing and analyzing various aspects of a player's 90 performance by listening to the player's 90 sounds made during the athletic event while simultaneously watching the player's movements on the video. The player 90 and coach 92 can use the information gathered during the review and analysis to make recommendations for improving the player's performance.

The method 100 may further include, as depicted as step 120 in FIG. 4, selectively choosing, with the user interface 30, one or more of the plurality of communication devices 12, 12a for transmitting and recording the sounds made by one or more respective players 90 and/or coach 92. Alternative to step 116, step 116′ includes synchronously playing on the media player 16 the video and only the chosen recorded sounds transmitted from the selected communication devices 12, 12a. Accordingly, alternative step 118′ includes reviewing and analyzing only the chosen recorded sounds and video together to evaluate the selected player(s)′ performance during the athletic event.

### Example—Volleyball

An example of using the present athletics training and communication system and associated method is provided, using volleyball as the illustrative sport. As is well known, volleyball is a team sport, and volleyball matches are played on a volleyball court that includes a raised net. Each team consists of six players, typically: a setter, a middle hitter, an outside hitter, a libero, a left back, and a right side hitter. Various play strategies and player formations can be used, and will vary based on the skill level of the team, the coach's preferences, etc.

Before the practice or match begins, one or more of the players 90 can be outfitted with the wireless communication device(s) 12. The communication device 12 can be clipped to the player's uniform and the video camera can be oriented to record the match. During the match, the verbal comments and sounds made by any of the outfitted players are transmitted and recorded by the transmitter 20 and media player 16. In addition, if the coach 92 is outfitted with a coach's communication device 12a, the comments and audible instructions made by the coach 92 can also be transmitted and recorded. In one example, multiple comments and audible instructions may be transmitted and recorded during a single period of play (i.e., a single point of a volleyball match), such that some of the comments made be made simultaneously and others sequentially.

Subsequent to the match, the audio and video streams can be listened to/watched together. The media player 16 can synchronously play the comments made by the outfitted player(s) 90, the audible instructions made by the coach 92, and the recorded video stream. Thus, the player's and/or team's performance can be reviewed an analyzed by watching the video while listening to the sounds made by player(s) 90 and coach 92.

Additionally, the training system 10 provides the ability to selectively listen to a chosen player(s) 90. During match play or playback and review, the coach 92 (or another operator) can select, through the user interface 30, which player's communication device 12 is active. For example, if the coach 92 is interested in reviewing and analyzing the setter's performance, the coach 92 has the ability to select just the setter's communication device 12. Accordingly, only the setter's communication device 12 is enabled to transmit sounds to the media player 16. Alternatively, all of the communication devices 12 can transmit throughout the entire match, and only the setter's communication device 12 can be selected for playback on the media player 16. It should be understood that selection of the active device(s) can be changed at any time, and more than one active device can be chosen.

The training system 10 enables the players and coach to review and analyze the volleyball player's performance. They are able to watch their movement and performance on the volleyball court, and listen to the comments they were making during the movement. This provides the ability to review and learn from their play strategies, court positions, athletic performance, etc.

Further, the players and coach can be provided with ear pieces 22. Including ear pieces 22 converts the training system 10 from a one-way communication system to a two-way communication system. Providing the players with ear pieces 22 enables the coach 92 to discretely communicate with the players 90. The coach 92 can relay strategies or provide feedback to the players during match play. As discussed above with respect to selecting which communication device(s) are active, the user interface 30 also enables the coach 92 to select which player's ear piece 22 is receiving the oral communication.

It should be understood that volleyball is merely an example of use for the training system 10. Other sports and activities are also contemplated.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Features of various embodiments may be used in combination with features from other embodiments. Directional terms, such as “vertical,” “horizontal,” “top,” “bottom,” “front,” “rear,” “upper,” “lower,” “inner,” “inwardly,” “outer,” “outwardly,” “forward,” and “rearward” are used to assist in describing the invention based on the orientation of the embodiments shown in the illustrations. The use of directional terms should not be interpreted to limit the invention to any specific orientation(s). Any reference to claim elements in the singular, for example, using the articles “a,” “an,” “the” or “said,” is not to be construed as limiting the element to the singular.

1. A method of athletics training comprising:
providing a microphone configured to receive sounds made by a teammate wearing the microphone during a selected time period of an athletic event;
wirelessly transmitting the sounds made by the teammate to a media player;
recording the sounds made by the teammate using the media player;
video recording the selected time period of the athletic event;
transmitting the recorded video to the media player;
after completion of the selected time period, synchronously playing on the media player the recorded sounds and video of the selected time period of the athletic event; and
reviewing and analyzing the sounds and the video together to evaluate the teammate's performance during the athletic event.

2. The method of claim 1 comprising:
providing a plurality of the microphones configured to receive sounds made by each of a plurality of teammates during an athletic event;
wirelessly transmitting and recording the sounds made by the plurality of teammates; and
wherein the step of reviewing and analyzing the sounds and the video together includes review and analysis of the video and sounds by at least one of the plurality of teammates.

3. The method of claim 2 wherein simultaneously playing the recorded sounds of the athletic event includes playing the sounds made by each of the plurality of teammates.

4. The method of claim 2 comprising selectively choosing one or more of the plurality of microphones for transmitting and recording the sounds made by one or more of the respective teammates.

5. The method of claim 4 comprising:
synchronously playing on the media player the video and the chosen recorded sounds made by the one or more respective teammates; and
reviewing and analyzing the chosen recorded sounds and the video together to evaluate the one or more respective teammates' performance during the athletic event.

6. The method of claim 1 comprising transmitting, in real-time, the sounds made by the teammate to a speaker mounted in an ear piece worn by an instructor.

7. The method of claim 6 comprising:
providing, to the instructor, a microphone configured to receive audible instructions made by the instructor wearing the microphone;
providing a speaker mounted in an ear piece worn by the teammate; and
transmitting, in real-time, the audible instructions made by the instructor to the speaker worn by the teammate, wherein communication between the teammate and the instructor is two-way wireless communication.

8. A method of athletics training comprising:
providing a plurality of microphones configured to wirelessly transmit sounds made by respective teammates, each teammate wearing one of the plurality of microphones during an athletic event;
providing a coach microphone configured to wirelessly transmit audible instructions made by an athletic coach during the athletic event;
recording, using a media player, the sounds made by the teammates and the audible instructions made by the coach;
providing a plurality of ear pieces configured to wirelessly receive and play the audible instructions made by the coach, each teammate wearing one of the plurality of ear pieces;
providing to the coach an ear piece configured to wirelessly receive and play the sounds made by the teammates;
video recording the athletic event and transmitting the recorded video to the media player;
synchronously playing on the media player the recorded sounds, the audible instructions, and the recorded video of the athletic event; and
after completion of the athletic event, reviewing and analyzing the sounds, the audible instructions, and the recorded video together to evaluate the teammates' performance during the athletic event.

9. The method of claim 8 comprising selectively choosing one or more of the plurality of microphones for transmitting the sounds made by one or more respective teammates.

10. The method of claim 9 wherein communication between the teammate and the coach is real-time, two-way wireless communication.

11. An athletics training and communication system for use by a coach and members of an athletic team, the training system comprising:
a first microphone configured transmit sounds made by a first teammate during an athletic event or practice;
a media player configured to receive and record the transmitted sounds made by the first teammate; and
a video camera for recording the athletic event or practice, the video camera configured to transmit the video stream to the media player;
wherein the media player synchronously plays the sounds made by the first teammate and the video such that the first teammate's performance during the athletic event or practice can be reviewed and analyzed after completion of the athletic event by watching the first teammate in the video while listening to the sounds made by the first teammate.

12. The athletics training and communication system of claim 11 including a plurality of microphones configured to receive and transmit sounds made by a plurality of teammates.

13. The athletics training and communication system of claim 12 including a mixer and a user input for selectively controlling which of the plurality of microphones is transmitting.

14. The athletics training and communication system of claim 13 including:
a coach's microphone configured to receive and transmit audible instructions made by a coach wearing the microphone; and
a plurality of ear pieces worn by the plurality of teammates, the ear pieces configured to receive and play the audible instructions made by the coach.

15. The athletics training and communication system of claim 14 wherein the mixer and user input are configured to selectively control which of the plurality of ear pieces worn by the respective teammates is receiving the audible instructions.

16. The athletics training and communication system of claim 15 wherein the mixer and user input are configured to selectively control which of the sounds made by the plurality of teammates and the audible instructions made by the coach are played on the media player, such that the one or more selected teammates' performance during the athletic event or practice can be reviewed and analyzed.

17. The athletics training and communication system of claim 16 wherein communication between the plurality of teammates and the coach is real-time, two-way wireless communication.
